(19) United States
(12) Patent Application Publication
(10) Pub. No.: US 2006/0203124 A1
(43) Pub. Date: Sep. 14, 2006

(54) Folder-type portable apparatus

(75) Inventors: In-Gon Park, Seoul (KR); Chang-Soo Lee, Bupyeong-gu (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/343,301

(22) Filed: Jan. 31, 2006

(30) Foreign Application Priority Data
Mar. 11, 2005 (KR) 2005-20625

(51) Int. Cl. H04N 5/225

(52) U.S. Cl. 348/376

(57) ABSTRACT

A folder-type portable apparatus including a body and a folder coupled to the body by a hinge device. An external display device having a first section and a second section, is disposed on the upper surface of the folder. A camera lens positioned adjacent to the external display device, and a sliding cover slides to reveal and cover the external device and the camera lens.

### PRIORITY

This application claims priority under 35 U.S.C. § 119 to an application entitled “Folder-Type Portable Apparatus” filed in the Korean Industrial Property Office on Mar. 11, 2005 and assigned Serial No. 2005-20625, the contents of which are hereby incorporated by reference.

### BACKGROUND OF THE INVENTION

1. Field of the Invention

The present invention relates generally to a folder-type portable apparatus such as a cellular phone, a PDA (personal digital assistant), an HHP (hand held phone), a camera phone, and a game phone, and more particularly to a folder-type portable apparatus, wherein exposed devices thereof can be protected and mode converting operations can be automatically performed.

2. Description of the Related Art

In general, a “portable communication apparatus” refers to an electronic apparatus, which a user can carry to perform wireless communication. In consideration of portability, designs of such portable communication apparatuses tend to be compact, slim, and lightweight. Additionally, for multimedia availability, these apparatuses have a wider variety of functions. In particular, future portable terminals are expected to incorporate greater multi-functionality and multi-purpose utilization, as well as greater compactness and lightness, but also will be modified to be suitable for various multimedia environments or Internet environments.

Conventional portable communication apparatuses are commonly classified according to their appearance, e.g., bar-type portable communication apparatuses, flip-type portable communication apparatuses, and folder-type portable communication apparatuses. The bar-type portable communication apparatus has a single housing shaped like a bar, the flip-type portable communication apparatus has a flip, which is pivotably mounted to a bar-shaped housing by a hinge device, and the folder-type portable communication apparatus has a folder coupled to a single bar-shaped housing by a hinge device in such a manner that the folder can be rotated in order to be folded to or unfolded from the housing.

Further, portable communication apparatuses may be classified into neck wearable type communication apparatuses and wrist wearable type communication apparatuses according to the position at or the way in which a user wears the communication apparatus. Obviously, the neck wearable type communication apparatus is worn around the neck using, for example, a string, and the wrist wearable type communication apparatus is worn around the wrist.

Additionally, portable communication apparatuses may be classified into rotation-type communication apparatuses and sliding-type communication apparatuses according to ways of opening and closing the communication apparatuses. In the rotation-type portable communication apparatus, two housings are coupled to each other in such a manner that one housing rotates to be opened or closed relative to the other. In the sliding-type portable communication apparatus, two housings are coupled to each other in such a manner that one housing slides along a longitudinal direction to be opened or closed relative to the other. These variously classified portable communication apparatuses can be easily understood by those skilled in the art.

Conventional portable communication apparatuses are now capable of transmitting data at a high speed in addition to the basic function of performing voice communication. That is, portable communication apparatuses now tend to provide a service using a wireless communication technology capable of transmitting data at a high speed.

Additionally, newer portable communication apparatuses include a camera lens, which enables each of the communication apparatuses to capture and transmit an image signal. That is, current conventional portable communication apparatuses may have an external or imbedded camera lens module, which enables a user to make an image communication with a desired partner or to take a photograph of a desired subject.

However, because most conventional portable communication apparatuses employ only one display device and only one speaker device, it is inconvenient to use them in various multimedia environments. Further, even though conventional portable communication apparatuses employ two display devices, they have a problem in that it is difficult to withstand external environments, such as dropping, cracking, and scratching, etc., in the absence of a separate device to protect the exposed display devices.

Therefore, in order to cope with such complex multimedia environments, there is a demand for a portable communication apparatus including at least two display devices, at least two speaker devices, and a camera lens, etc. Additionally, there is a demand for a separate means for protecting devices that are externally disposed on the portable communication apparatus and likely to be damaged.

### SUMMARY OF THE INVENTION

Accordingly, the present invention has been designed to solve the above and other problems occurring in the prior art. An object of the present invention is to provide a folder-type portable apparatus, which enables external display devices to be doubly protected.

Another object of the present invention is to provide a folder-type portable apparatus including a number of projected edges, which enclose the external display devices for protection.

Still another object of the present invention is to provide a folder-type portable apparatus including a sliding cover for protecting external display devices.

Still another object of the present invention is to provide a folder-type portable apparatus including a sliding cover for protecting a camera lens.

Still another object of the present invention is to provide a folder-type portable apparatus including a sliding cover for protecting the external display devices or the camera lens.

Still another object of the present invention is to provide a folder-type portable apparatus including two internal and external display devices, and two internal and external speaker devices.

Still another object of the present invention is to provide a folder-type portable apparatus having an external display device and a camera lens capable of being automatically powered on/off by a sliding cover.

Still another object of the present invention is to provide a folder-type portable apparatus having first and second sections of the external display device capable of being automatically powered on/off by a sliding cover.

Still another object of the present invention is to provide a folder-type portable apparatus having a camera lens capable of being automatically powered on/off by a sliding cover.

In order to accomplish the above and other objects, in accordance with one aspect of the present invention, there is provided a folder-type portable apparatus. The apparatus includes: a body; a folder coupled to the body by a hinge device in such a manner that the folder can be rotated in order to be folded to or unfolded from the body; an external display device disposed on the upper surface of the folder, and formed with a first section and a second section adjacent to the first section; a camera lens positioned adjacent to the external display device; and a sliding cover kept its position facing with the external display device and, through its sliding motion, adapted to open the first section only in a first position, open the second section/camera lens only in a second position, and open a portion of the first section/camera lens only in a third position.

In accordance with another aspect of the present invention, there is provided a folder-type portable apparatus. The apparatus includes a body; a folder coupled to the body by a hinge device in such a manner that the folder can be rotated in order to be folded to or unfolded from the body; an external display device disposed on the upper surface of the folder; a number of projected edges enclosing around the external display device and projecting from the upper surface of the external display device to protect it; and a sliding cover kept its position facing with the external display device and, through its sliding motion, adapted to open the first section only in a first position, open the second section/camera lens only in a second position, and open a portion of the first section/camera lens only in a third position.

In accordance with still another aspect of the present invention, there is provided a folder-type portable apparatus. The apparatus includes a body; a folder coupled to the body by a hinge device in such a manner that the folder can be rotated in order to be folded to or unfolded from the body; an external display device disposed on the upper surface of the folder; an internal display device disposed on the lower surface of the folder; an external speaker device disposed on the upper surface of the folder with adjacent to the external display device; an internal speaker device disposed on the lower surface of the folder with adjacent to the external display device; a number of projected edges enclosing around the external display device and projecting from the upper surface of the external display device to protect it; and a sliding cover kept its position facing with the external display device and adapted to move in order to open and close a portion of the external display device only.

### BRIEF DESCRIPTION OF THE DRAWINGS

The above and other objects, features, and advantages of the present invention will be more apparent from the following detailed description taken in conjunction with the accompanying drawings, in which:

FIG. 1 is a perspective view illustrating a folder-type portable apparatus according to a preferred embodiment of the present invention;

FIG. 2 is a plan view of a folder-type portable apparatus illustrated in FIG. 1;

FIG. 3 is a plan view illustrating a folder-type portable apparatus according to a preferred embodiment of the present invention, wherein a folder has been completely opened;

FIG. 4 is a perspective view illustrating a folder-type portable apparatus according to a preferred embodiment of the present invention, wherein a sliding cover has been slightly moved;

FIG. 5 is a perspective view illustrating a folder-type portable apparatus according to a preferred embodiment of the present invention, wherein a sliding cover has been completely moved; and

FIG. 6 is a plan view of a folder-type portable apparatus illustrated in FIG. 5.

### DETAILED DESCRIPTION OF THE PREFERRED EMBODIMENT

Preferred embodiments of the present invention will be described in detail herein below with reference to the accompanying drawings. Further, in the following description of the present invention, a detailed description of known functions and configurations incorporated herein will be omitted when it may obscure the subject matter of the present invention.

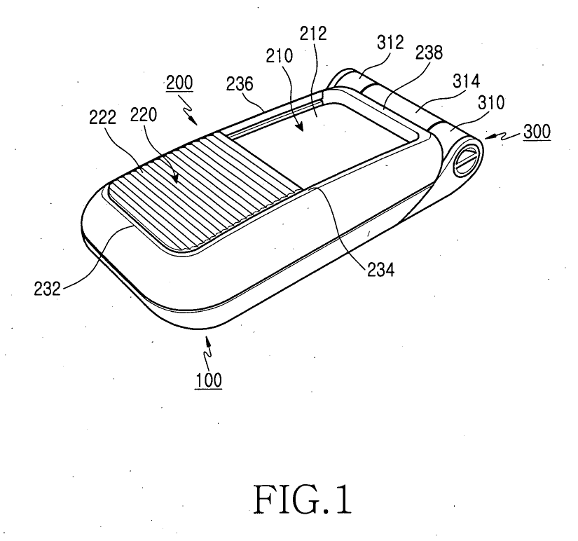

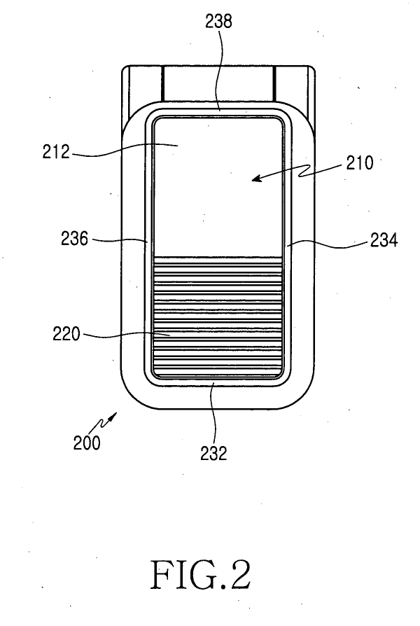

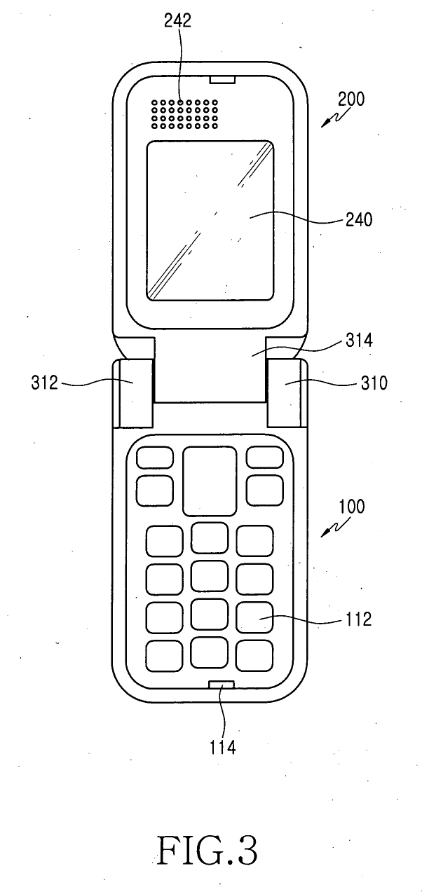

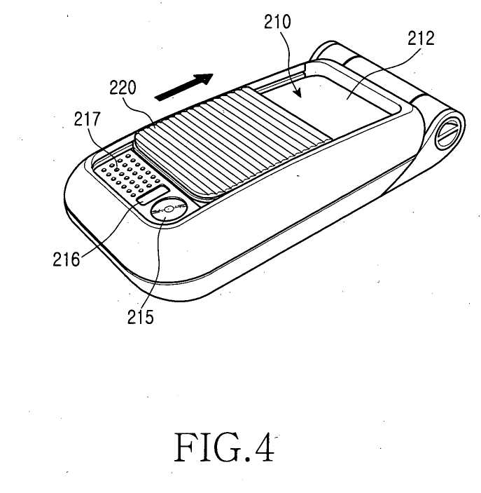

FIG. 1 is a perspective view illustrating a folder-type portable apparatus according to a preferred embodiment of the present invention, and FIG. 2 is a plan view of a folder-type portable apparatus illustrated in FIG. 1. Referring to FIGS. 1 and 2, the folder-type portable apparatus according to the present invention includes raised edges 232, 234, 236, and 238, which project along the circumference of an external display device 210 to protect the external display device 210 provided on a folder 200, and a sliding cover 220, which can slide over the external display device 210. Further, the portable apparatus according to the present invention includes two internal and external display devices 210 and 240 (see FIG. 3) and two internal and external speaker devices 242 (see FIG. 3) and 217 (see FIG. 4), which are conveniently used at a camera mode, a self-shot mode, and an image communication mode.

The folder-type portable apparatus includes a body 100, a folder 200, and a hinge device 300, which rotatably interconnects the body 100 and the folder 200 in such a manner that the folder 200 can be folded to or unfolded from the body 100. The folder 200 includes an external display device 210 disposed on the upper surface thereof, and a sliding cover 220 disposed on the external display device 210 so as to cover the external display device 210. Further, the folder 200 has raised edges 232, 234, 236, and 238, which project from the entire circumference of the external display device 210. More specifically, the edges 232, 234, 236, and 238 are projected over the upper surface of the external display device 210 in such a manner that they prevent the external display device 210 from being damaged or scratched, and also assist the guiding function of the sliding cover 220. In particular, the edges 232, 234, 236, and 238 continuously extend along the circumference of the external display device 210, thereby enclosing the entire circumference thereof.

The sliding cover 220 slides while being closely opposed to the external display device 210 in order to cover or reveal the upper surface of the folder 200. The sliding cover 220 is provided with, at the upper surface thereof, a plurality of protrusions 222 and each protrusion 222 extends along an axis of the hinge device 300 such that they easily perform the sliding motion.

FIG. 3 is a plan view illustrating a folder-type portable apparatus according to a preferred embodiment of the present invention, wherein a folder has been completely opened. Referring to FIG. 3, the body 100 includes, at the upper surface thereof, a plurality of keys 112 and a microphone device 114 positioned adjacent to the keys 112. The folder 200 includes, at the lower surface thereof, an internal speaker device 242 and an internal display device 240 positioned adjacent to the internal speaker device 242. The external display device 210 illustrated in FIG. 1 is always exposed to the external environment, while the internal display device 240 is exposed to the external environment only when the folder 200 has been opened from the body 100. Likewise, the external speaker device 217 illustrated in FIG. 4, is always exposed to the external environment, while the internal speaker device 242 is exposed to the external environment only when the folder 200 has been opened from the body 100.

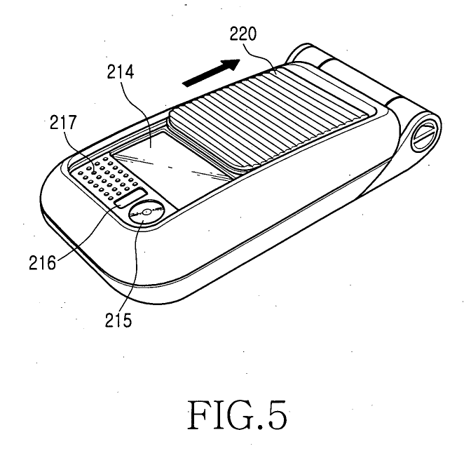

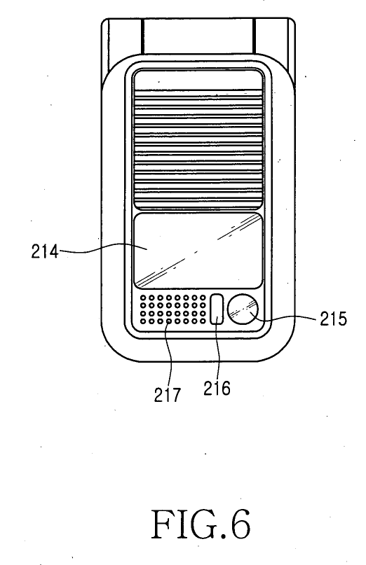

FIG. 4 is a perspective view illustrating a folder-type portable apparatus according to a preferred embodiment of the present invention, wherein a sliding cover has been slightly moved, FIG. 5 is a perspective view illustrating a folder-type portable apparatus according to a preferred embodiment of the present invention, wherein a sliding cover has been completely moved, and FIG. 6 is a plan view of a folder-type portable apparatus illustrated in FIG. 5. Referring to FIGS. 4 to 6, the external display device 210 is divided into two sections, which are determined by the sliding of the sliding cover 220. The external display device 210 includes a first section 212 and a second section 214. The first and second sections 212 and 214 may be formed with only one external display device or separately formed with two external display devices, respectively. The external display device 210 is preferably a liquid crystal display device, however, may be a touch screen.

The folder 200 is provided with a camera lens 215, an illuminating device 216, and an external speaker device 217. Preferably, the camera lens 215 is disposed adjacent to the second section 214 of the external display device and the illuminating device 216. The illuminating device 216 is immediately adjacent to the camera lens 215, the external speaker device 217, and the second section 214 of the external display device. Further, the external speaker device 217 is disposed adjacent to the illuminating device 216 and the second section 214 of the external display device.

During operation, as illustrated in FIG. 1, in a first position where the sliding cover 220 has not moved, only the first section 212 is exposed. However, as illustrated in FIG. 5, in a second position where the sliding cover 220 is completely slid over the first section 212, the sliding cover 220 reveals the second section 214, camera lens 215, the illuminating device 216, and the external speaker device 217. In FIG. 4, in a third position where the sliding cover 220 has not completely covered the first section 212, the sliding cover 220 reveals only the camera lens 215, the illuminating device 216, and the external speaker device 217, and keeps the second section 214 covered.

Accordingly, when the camera lens 215 is uncovered, the illuminating device 216 and the external speaker device 217 are opened along with it, and when the camera lens 215 is covered, the illuminating device 216 and the external speaker device 217 are closed along with it.

Preferably, the first section 212 of the external display device 204 displays information that a user should often look at, for example, time, date, antenna reception sensitivity, battery charge level, message status, etc.

Further, the camera lens 215, the illuminating device 216, and the external speaker device 217 are preferably positioned on the folder 200 spaced apart from the hinge device 300, thereby making it more convenient to take a photograph of a desired subject when a camera mode or self-shot mode.

Additionally, as illustrated in FIG. 1, i.e., when the sliding cover 220 is in the first position, the first section 212 of the display device is powered on, and the second section 214 is powered off. Further, in FIG. 5, i.e., when the sliding cover 220 is completely slid, the first section 212 of the display device is powered off, and the second section 214 is powered on, while the camera lens 215, the illuminating device 216, and the external speaker device 217 can also be powered on.

Preferably, the extent of the motion of the sliding cover 220 will be detected by a sensor (not shown) so that it can be determined according to the detected signals. As a result, if the first and second section 212 and 214 of the display device have been revealed by the sliding cover 220 they can be powered on, and if closed, they can be powered off. Further, the camera lens 215, the illuminating device 216, and the external speaker device 217 can also operate in the same manner.

As described above, the folder-type portable apparatus according to the present invention is advantageous in that the apparatus enables external devices exposed thereon to be doubly protected, i.e., from the raised edges and the sliding cover, and at least two display devices and at least two speaker devices are conveniently arranged, so that it can be conveniently used.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A folder-type portable apparatus comprising:
a body;
a folder coupled to the body by a hinge device in such a manner that the folder folds to and unfolds from the body;
an external display device disposed on an upper surface of the folder, having a first section and a second section;
a camera lens positioned adjacent to the external display device; and
a sliding cover positioned over the external display device, which slides to cover the second section and the camera lens and to reveal only the first section in a first position, slides to cover the first section and to reveal the second section, and the camera lens in a second position, and slides to cover the second section and to reveal a portion of the first section and the camera lens in a third position.

2. The folder-type portable apparatus as claimed in claim 1, the sliding cover comprises a plurality of protrusions, on an upper surface thereof, which extend along an axis of the hinge device, for providing a grip to easily perform a sliding motion.

3. The folder-type portable apparatus as claimed in claim 1, further comprising an illuminating device and an external speaker device.

4. The folder-type portable apparatus as claimed in claim 3, wherein the illuminating device and the external display device are revealed and covered by the sliding cover along with the camera lens.

5. The folder-type portable apparatus as claimed in claim 1, the first and second sections and the camera lens are powered on when revealed and powered off when covered.

6. The folder-type portable apparatus as claimed in claim 5, wherein the camera lens is powered on when revealed and powered off when covered.

7. The folder-type portable apparatus as claimed in claim 1, further comprising a raised edge surrounding a perimeter of the external display device and the camera lens for guiding the sliding cover and protecting the external display device and the camera lens.

8. A folder-type portable apparatus comprising:
a body;
a folder coupled to the body by a hinge device in such a manner that the folder folds to and unfolds from the body;
an external display device disposed on an upper surface of the folder, having a first section and a second section;
a camera lens positioned adjacent to the external display device;
a raised edge enclosing the external display device and the camera lens and projecting from the upper surface of the folder; and
a sliding cover positioned over the external display device, which slides to cover the second section and the camera lens and to reveal only the first section in a first position, slides to cover the first section and to reveal the second section, and the camera lens in a second position, and slides to cover the second section and to reveal a portion of the first section and the camera lens in a third position.

9. A folder-type portable apparatus comprising:
a body;
a folder coupled to the body by a hinge device in such a manner that the folder folds to and unfolds from the body;
an external display device disposed on an upper surface of the folder, having a first section and a second section;
an internal display device disposed on the lower surface of the folder;
an external speaker device disposed on the upper surface of the folder with adjacent to the external display device;
an internal speaker device disposed on the lower surface of the folder with adjacent to the external display device;
a raised edge enclosing the external display device and projecting from the upper surface of the folder; and
a sliding cover positioned over the external display in the raised edges, which slides to cover the second section and to reveal the first section in a first position, and slides to cover the first section and to reveal the second section a second position.

10. The folder-type portable apparatus as claimed in claim 9, wherein the first section and the second section are powered on when revealed, and are powered off when covered.
